(19) United States
(12) Patent Application Publication
(10) Pub. No.: US 2024/0339639 A1
(43) Pub. Date: Oct. 10, 2024

(54) Rapidly Deployable Redox Flow Battery Energy Storage System

(71) Applicant: STEWART & STEVENSON LLC, Houston, TX (US)

(72) Inventor: Ryan LOOFS, Leander, TX (US)

(21) Appl. No.: 18/609,558

(22) Filed: Mar. 19, 2024

Related U.S. Application Data
(60) Provisional application No. 63/457,004, filed on Apr. 4, 2023.

(51) Int. Cl. H01M 8/04082; H01M 8/18

(52) U.S. Cl. CPC H01M 8/04201; H01M 8/188; H01M 2250/20

(57) ABSTRACT

A system includes a redox battery energy storage system. The redox battery energy storage system includes a battery energy system mobile platform and a reaction cell, the reaction cell having an anode and a cathode separated by an ion-exchange membrane, mounted to the battery energy mobile platform. The redox battery energy storage system also includes an external power interface. The system includes a bulk anolyte tanker system including an anolyte mobile platform and an anolyte bulk fluid storage tank, the first anolyte bulk fluid storage tank mounted on the first anolyte mobile platform and fluidly and detachably connected to the reaction cell. In addition, the system includes a bulk catholyte tanker system including a catholyte mobile platform and a catholyte bulk fluid storage tank, the catholyte bulk fluid storage tank mounted on the catholyte mobile platform and fluidly and detachably connected to the reaction cell.

### CROSS-REFERENCE TO RELATED APPLICATIONS

This application is a nonprovisional application which claims priority from U.S. provisional application No. 63/457,004, filed Apr. 4, 2023, which is incorporated by reference herein in its entirety.

### TECHNICAL FIELD/FIELD OF THE DISCLOSURE

The present disclosure relates generally to energy storage systems.

### BACKGROUND OF THE DISCLOSURE

Redox flow batteries are one type of energy storage device. “Redox” refers to chemical reduction and oxidation reactions within the redox flow batteries to store energy in liquid electrolyte solutions that flow through a battery of electrochemical cells during charge and discharge.

During discharge, electrons are released in the oxidation reaction from a high chemical potential state on the negative or anode side of the battery. The electrons typically move through an external circuit. The electrons are then accepted via a reduction reaction at a lower chemical potential state on the positive or cathode side of the battery. The direction of the current and the chemical reactions are reversed during charging of the redox flow battery.

### SUMMARY

The disclosure includes a system. The system includes a redox battery energy storage system. The redox battery energy storage system includes a battery energy system mobile platform and a reaction cell, the reaction cell having an anode and a cathode separated by an ion-exchange membrane, the reaction cell mounted to the battery energy mobile platform. The redox battery energy storage system also includes an external power interface in electrical connections with the anode and the cathode. The system also includes a first bulk anolyte tanker system, the first bulk anolyte tanker system including a first anolyte mobile platform and a first anolyte bulk fluid storage tank, the first anolyte bulk fluid storage tank mounted on the first anolyte mobile platform and fluidly and detachably connected to the reaction cell. In addition, the system includes a first bulk catholyte tanker system, the first bulk catholyte tanker system including a first catholyte mobile platform and a first catholyte bulk fluid storage tank, the first catholyte bulk fluid storage tank mounted on the first catholyte mobile platform and fluidly and detachably connected to the reaction cell.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic depiction of a redox flow battery energy storage system consistent with certain embodiments of the present disclosure.

FIGS. 2A, 2B are schematic depictions of a redox flow battery energy storage system consistent with certain embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

In certain embodiments of this disclosure the redox flow battery energy storage system may include a battery cell array, with associated controls and power electronics and external power interfaces are located on a common mobile platform such as a skid or trailer to facilitate rapid deployment without need for significant onsite integration prior to operation/startup. Energy storage capacity may be provided to this system via connection to one or more pairs of anolyte and catholyte tankers, each of which may include a bulk fluid storage and containment unit, a pump, a transfer interface manifold, and thermal and flow controls. When more than one pair of anolyte and catholyte tankers are used, the tanks may be connected serially to increase system energy storage capacity (i.e. by increasing the total volume of charge-carrying fluids) or in parallel to facilitate hot-swap exchange of the anolyte and catholyte fluids (i.e. by replacing depleted fluids with fresh fluids) as described previously.

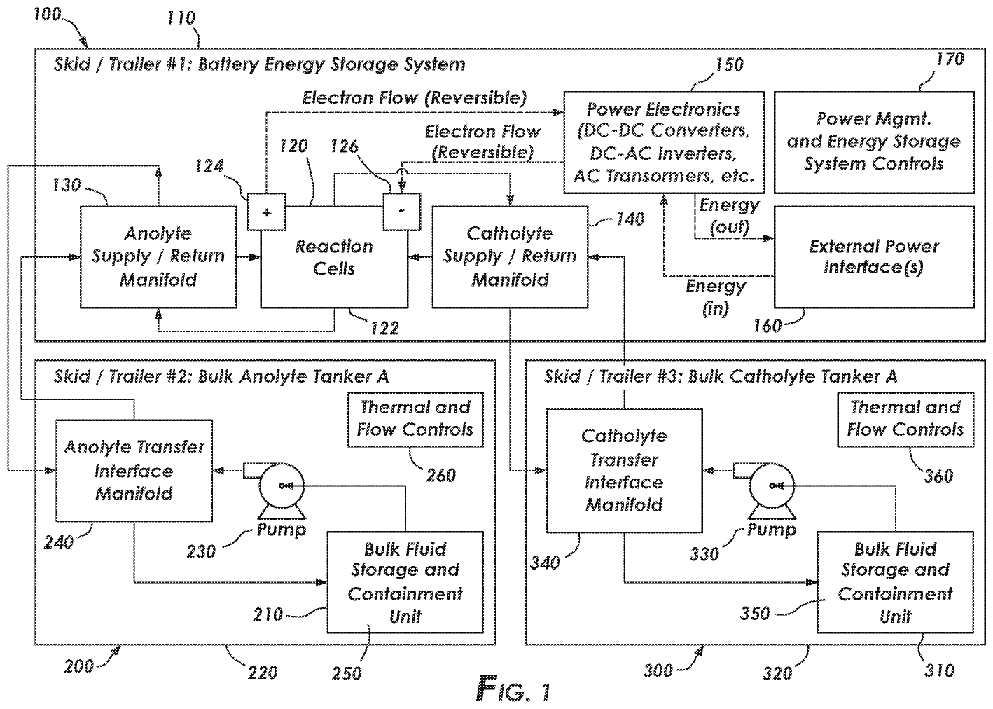

FIG. 1 depicts redox flow battery energy storage system 100, consistent with certain embodiments of the present disclosure. Redox flow battery energy storage system 100 includes reaction cell 120 positioned on battery energy storage system mobile platform 110. Battery energy storage system mobile platform may in certain examples be a skid or trailer. Reaction cell 120 may be an electrochemical energy storage device in which the charge-carrying poles i.e., anode 124 and cathode 126 are in fluid form (termed “anolyte” and “catholyte”, respectively), typically as liquids, and are circulated through a reaction cell while separated from one another by ion-exchange membrane 122 that allows a reversible reduction-oxidation, i.e., redox, reaction to take place by facilitating the flow of electrons across an external electrical circuit while the corresponding positively-charged ions transfer across ion-exchange membrane 122. Battery energy storage system mobile platform 110 may be, for example, a skid or a trailer. Anolyte supply/return manifold 130 may be mounted on battery energy storage system mobile platform 110 and fluidly connected to reaction cell 120. Similarly, catholyte supply/return manifold 140 may be mounted to battery energy storage system mobile platform 110 and fluidly connected to reaction cell 120. Reaction cell 120 may be electrically connected to power electronics 150, which may be mounted on battery energy storage system mobile platform 110. Power electronics 150 may include DC-DC converters, DC-AC inverters, AC-DC inverters, AC transformers, and filters. Power electronics 150 may be electrically connected to external power interface 160, which may be mounted on battery energy storage system mobile platform 110. External power interface 160 may include a tie in point for an external circuit. Also electrically connected to reaction cell 120 and mounted on battery energy storage system mobile platform 110 is power management and energy storage system controls 170. Power management and energy storage system controls may be used to control the operation of reaction cell 120 and of power electronics 150.

FIG. 1 further depicts bulk anolyte tanker system 200. The elements of bulk anolyte tanker system 200 may be positioned on anolyte mobile platform 220, for example, anolyte bulk fluid storage tank 210. Anolyte mobile platform 220 may be in certain examples a trailer or a skid. In certain non-limiting examples, anolyte bulk fluid storage tank 210 may be a tank trailer or tank truck. Anolyte bulk fluid storage tank 210 may be fluidly connected to anolyte pump 230 and anolyte transfer interface manifold 240, both of which may be mounted on anolyte mobile platform 220. Anolyte transfer interface manifold 240 may be fluidly and detachably connected to anolyte supply/return manifold 130 of battery energy storage system mobile platform 110. In certain embodiments, bulk anolyte tanker system 200 includes bulk fluid storage & containment unit 250. Further, in some embodiments, bulk anolyte tanker system 200 may include anolyte thermal & flow controls 260. Anolyte thermal & flow controls 260 may be electrically connected to anolyte pump 230 and anolyte transfer interface manifold 240 to control anolyte flow in and out of bulk fluid storage & containment unit 250. Further, anolyte thermal & flow controls 260 may monitor the temperature of the anolyte within anolyte bulk fluid storage tank 210. Anolyte thermal & flow controls 260 may also provide heating or cooling of the anolyte.

In addition, FIG. 1 depicts bulk catholyte tanker system 300. The elements of bulk catholyte tanker system 300 may be positioned on catholyte mobile platform 320, for example, catholyte bulk fluid storage tank 310. Catholyte mobile platform 320 may be in certain examples a trailer or a skid. In certain non-limiting examples, catholyte bulk fluid storage tank 310 may be a tank trailer or tank truck. Catholyte bulk fluid storage tank 310 may be fluidly connected to catholyte pump 330 and catholyte transfer interface manifold 340, both of which may be mounted on catholyte mobile platform 320. Catholyte transfer interface manifold 340 may be fluidly and detachably connected to catholyte supply/return manifold 140 battery positioned on battery energy storage system mobile platform 110. In certain embodiments, bulk catholyte tanker system 300 includes catholyte containment unit 350. Further, in some embodiments, bulk catholyte tanker system 300 may include catholyte thermal & flow controls 360. Catholyte thermal & flow controls 360 may be electrically connected to catholyte pump 330 and catholyte transfer interface manifold 340 to control catholyte flow in and out of bulk fluid storage & containment unit 250. Further, catholyte thermal & flow controls 360 may monitor the temperature of the catholyte within catholyte bulk fluid storage tank 310. Catholyte thermal & flow controls 360 may also provide heating or cooling of the catholyte.

During discharge operation, the anolyte and the catholyte are introduced into reaction cell 120 on opposite sides of ion-exchange membrane 122. Electrons released by the cell through anode 124 are passed through power electronics 150 to external power interface 160, which connects to an external load. The circuit is completed by transferring electrons from external power interface 160 through power electronics 150 and back to reaction cell 120 through cathode 126. The anolyte may be transferred from anolyte bulk fluid storage tank 210 by anolyte pump 230 and through anolyte transfer interface manifold 240. From anolyte transfer interface manifold 240, anolyte is transferred through anolyte supply/return manifold 130 to reaction cell 120. Anolyte from reaction cell 120 is transferred back through anolyte supply/return manifold 130 to and through anolyte transfer interface manifold 240 back into anolyte bulk fluid storage tank 210.

Catholyte is similarly transferred. The catholyte may be transferred from catholyte bulk fluid storage tank 310 by catholyte pump 330 and through catholyte transfer interface manifold 340. From catholyte transfer interface manifold 340, catholyte is transferred through catholyte supply/return manifold 140 to reaction cell 120. Catholyte from reaction cell 120 is transferred back through catholyte supply/return manifold 140 to and through catholyte transfer interface manifold 340 back into catholyte bulk fluid storage tank 310.

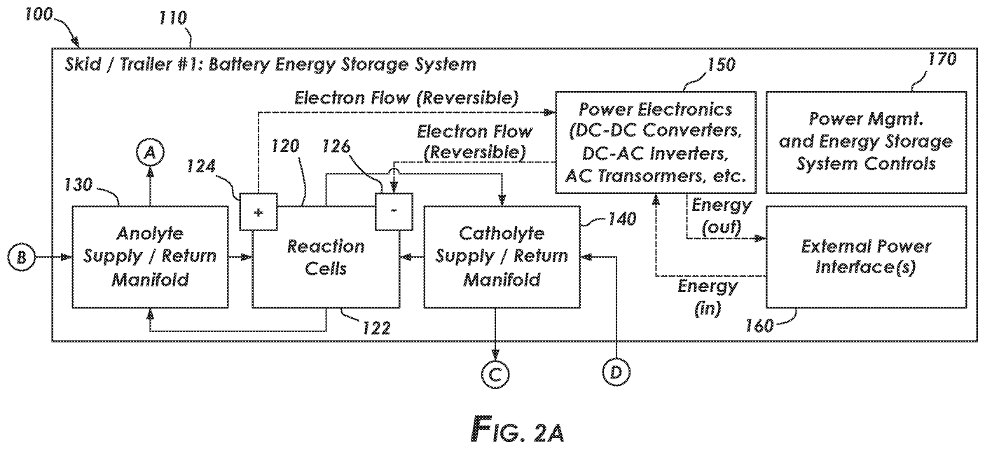

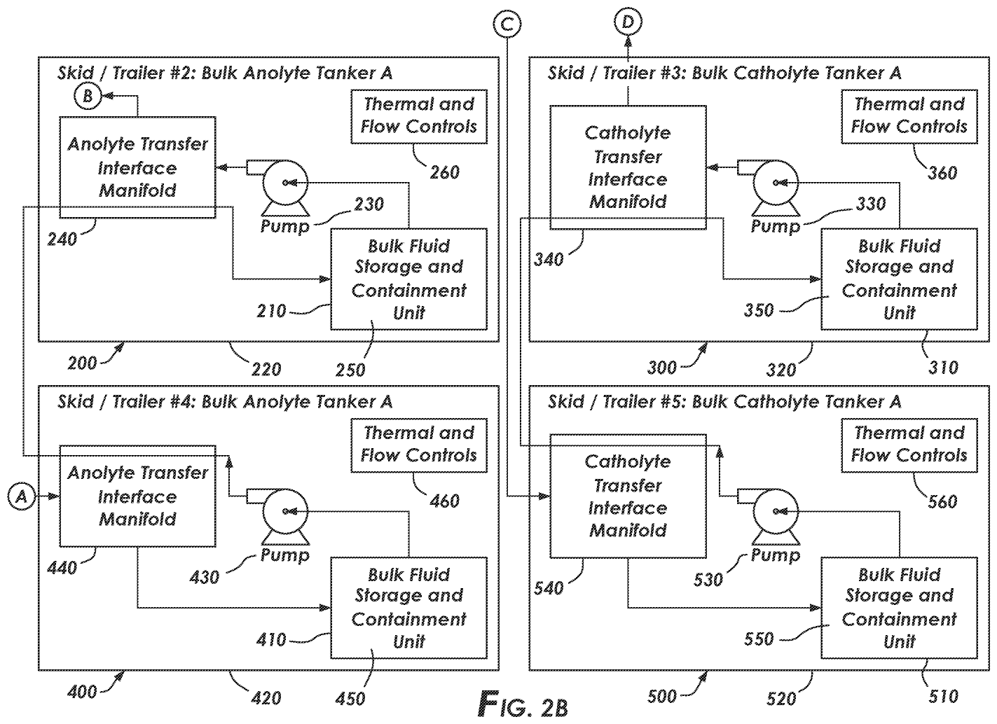

FIGS. 2A, 2B depict an alternative embodiment of redox flow battery energy storage system 100 wherein at least two bulk anolyte tanker systems 200 and 400 and two bulk catholyte tanker systems 300 and 500 are used. Bulk anolyte tanker system 200 and bulk catholyte tanker system 300 are described above.

FIG. 2B further depicts bulk anolyte tanker system 400. The elements of bulk anolyte tanker system 400 may be positioned on anolyte mobile platform 420, for example, anolyte bulk fluid storage tank 410. In certain non-limiting examples, anolyte bulk fluid storage tank 410 may be a tank trailer or tank truck. Anolyte bulk fluid storage tank 410 may be fluidly connected to anolyte pump 430 and anolyte transfer interface manifold 440, both of which may be mounted on anolyte mobile platform 420. Anolyte transfer interface manifold 440 may be fluidly and detachably connected to anolyte supply/return manifold 130 when bulk anolyte tanker system 400 is in parallel connection with bulk anolyte tanker system 200 and to anolyte bulk fluid storage tank 210 when in series connection. In certain embodiments, bulk anolyte tanker system 400 includes bulk fluid storage & containment unit 450. Further, in some embodiments, bulk anolyte tanker system 400 may include anolyte thermal & flow controls 460. Anolyte thermal & flow controls 460 may be electrically connected to anolyte pump 430 and anolyte transfer interface manifold 440 to control anolyte flow in and out of bulk fluid storage & containment unit 450. Further, anolyte thermal & flow controls 460 may monitor the temperature of the anolyte within anolyte bulk fluid storage tank 210. Anolyte thermal & flow controls 460 may also provide heating or cooling of the anolyte.

In addition, FIG. 2B depicts bulk catholyte tanker system 500. The elements of bulk catholyte tanker system 500 may be positioned on catholyte mobile platform 520, for example, catholyte bulk fluid storage tank 510. In certain non-limiting examples, catholyte bulk fluid storage tank 510 may be a tank trailer or tank truck. Catholyte bulk fluid storage tank 510 may be fluidly connected to catholyte pump 530 and catholyte transfer interface manifold 540, both of which may be mounted on catholyte mobile platform 320. Catholyte transfer interface manifold 540 may be fluidly and detachably connected to catholyte supply/return manifold 140 battery positioned on battery energy storage system mobile platform 110 when bulk catholyte tanker system 500 is in parallel connection with bulk catholyte tanker system 300 and to catholyte bulk fluid storage tank 310 when in series connection. In certain embodiments, bulk catholyte tanker system 500 includes bulk fluid storage & containment unit 550. Further, in some embodiments, bulk catholyte tanker system 500 may include catholyte thermal & flow controls 560. Catholyte thermal & flow controls 560 may be electrically connected to catholyte pump 530 and catholyte transfer interface manifold 540 to control catholyte flow in and out of bulk fluid storage & containment unit 550. Further, catholyte thermal & flow controls 560 may monitor the temperature of the catholyte within catholyte bulk fluid storage tank 510. Catholyte thermal & flow controls 560 may also provide heating or cooling of the catholyte.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A system comprising:
a redox battery energy storage system, the redox battery energy storage system including:
a battery energy system mobile platform;
a reaction cell, the reaction cell having an anode and a cathode separated by an ion-exchange membrane, the reaction cell mounted to the battery energy mobile platform; and
an external power interface in electrical connections with the anode and the cathode;
a first bulk anolyte tanker system, the first bulk anolyte tanker system including:
a first anolyte mobile platform; and
a first anolyte bulk fluid storage tank, the first anolyte bulk fluid storage tank mounted on the first anolyte mobile platform and fluidly and detachably connected to the reaction cell; and
a first bulk catholyte tanker system, the first bulk catholyte tanker system including:
a first catholyte mobile platform; and
a first catholyte bulk fluid storage tank, the first catholyte bulk fluid storage tank mounted on the first catholyte mobile platform and fluidly and detachably connected to the reaction cell.

2. The system of claim 1, wherein the at least one of the battery energy system mobile platform, first anolyte mobile platform, or first catholyte mobile platform is a skid or trailer.

3. The system of claim 1, wherein the first anolyte bulk fluid storage tank is a tank trailer or tank truck.

4. The system of claim 1, wherein the first catholyte bulk fluid storage tank is a tank trailer or tank truck.

5. The system of claim 1 further including:
an anolyte supply/return manifold mounted on the first battery energy storage system mobile platform;
a catholyte supply/return manifold mounted to the first battery energy storage system mobile platform;
a first anolyte transfer interface manifold mounted to the first anolyte mobile platform, wherein the first anolyte transfer interface manifold is fluidly and detachably connected to the anolyte supply/return manifold;
a first catholyte transfer interface manifold mounted to the first catholyte mobile platform, wherein the first catholyte transfer interface manifold is fluidly and detachably connected to the anolyte supply/return manifold.

6. The system of claim 1 further comprising power electronics in electrical connection to the reaction cell and mounted on the battery energy storage system mobile platform.

7. The system of claim 6, wherein the power electronics include DC-DC converters, DC-AC inverters, AC-DC inverters, AC transformers, and filters.

8. The system of claim 1 further comprising
a second bulk anolyte tanker system, the second bulk anolyte tanker system including:
a second anolyte mobile platform; and
a second anolyte bulk fluid storage tank, the second anolyte bulk fluid storage tank mounted on the second anolyte mobile platform and fluidly and detachably connected to the reaction cell; and
a second bulk catholyte tanker system, the second bulk catholyte tanker system including:
a second catholyte mobile platform; and
a second catholyte bulk fluid storage tank, the second catholyte bulk fluid storage tank mounted on the second catholyte mobile platform and fluidly and detachably connected to the reaction cell.

9. The system of claim 8, wherein the first anolyte bulk fluid storage tank and second anolyte bulk fluid storage tank are connected in series to the reaction cell.

10. The system of claim 8, wherein the first anolyte bulk fluid storage tank and second anolyte bulk fluid storage tank are connected in parallel to the reaction cell.

11. The system of claim 8, wherein the first catholyte bulk fluid storage tank and second catholyte bulk fluid storage tank are connected in series to the reaction cell.

12. The system of claim 8, wherein the first catholyte bulk fluid storage tank and second catholyte bulk fluid storage tank are connected in parallel to the reaction cell.
